(19) United States
(12) Patent Application Publication
(10) Pub. No.: US 2018/0374275 A1
(43) Pub. Date: Dec. 27, 2018

(54) INFORMATION PROCESSING METHOD AND APPARATUS, AND PROGRAM FOR EXECUTING THE INFORMATION PROCESSING METHOD ON COMPUTER

(71) Applicant: COLOPL, Inc., Tokyo (JP)

(72) Inventors: Atsushi INOMATA, Kanagawa (JP); Eita KIKUCHI, Tokyo (JP); Takashi NAKABO, Tokyo (JP)

(21) Appl. No.: 15/984,269

(22) Filed: May 18, 2018

(30) Foreign Application Priority Data
May 19, 2017 (JP) 2017-099898

(51) Int. Cl. G06T 19/20; G06F 3/01; G02B 27/01; G06T 7/20

(52) U.S. Cl. CPC G06T 19/20; G06F 3/011; G02B 2027/014; G06T 7/20; G02B 2027/0138; G02B 27/0172

(57) ABSTRACT

A method includes acquiring first content data. The method further includes defining a virtual space based on the first content data. The method further includes generating image data of a still image corresponding to a portion of the virtual space. The method further includes associating the image data with the first content data. The method further includes receiving instructions for replacing the first content data with second content data. The method further includes updating the image data to replace the first content data with the second content data in response to the receiving of the instructions for replacing.

### RELATED APPLICATIONS

The present application claims priority to Japanese Application No. 2017-099898, filed on May 19, 2017, the disclosure of which is hereby incorporated by reference herein in its entirety.

### TECHNICAL FIELD

This disclosure relates to an information processing method and an apparatus for executing the information processing method.

### BACKGROUND

In Non-Patent Document 1, there is described a technology for moving an avatar object associated with a user in a virtual space based on an operation by the user.

### Non-Patent Documents

[Non-Patent Document 1] “Facebook Mark Zuckerberg Social VR Demo OC3 Oculus Connect 3 Keynote”, [online], Oct. 6, 2016, VRvibe, [retrieved on Dec. 5, 2016], Internet <https://www.youtube.com/watch?v=NCpNKLXovtE>

### SUMMARY

According to at least one embodiment of this disclosure, there is provided an information processing method including acquiring first content data. The method further includes defining a virtual space based on the first content data. The method further includes generating image data of a still image corresponding to a portion of the virtual space. The method further includes associating the image data and the first content data with each other. The method further includes detecting a replacement from the first content data to second content data. The method further includes updating the image data so as to correspond to the second content data in accordance with the detection of the replacement.

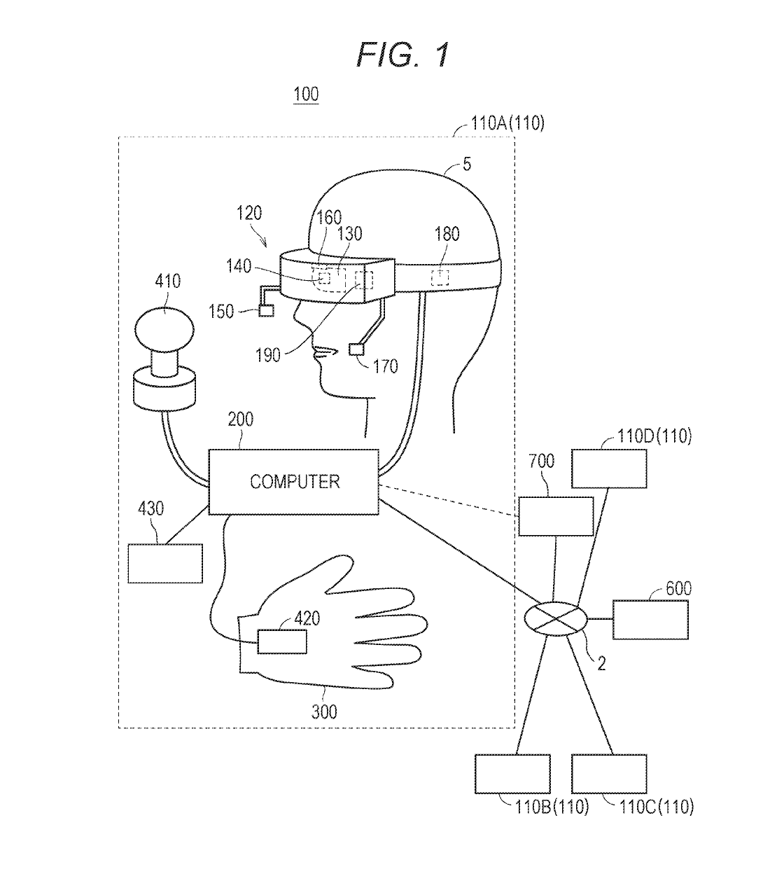

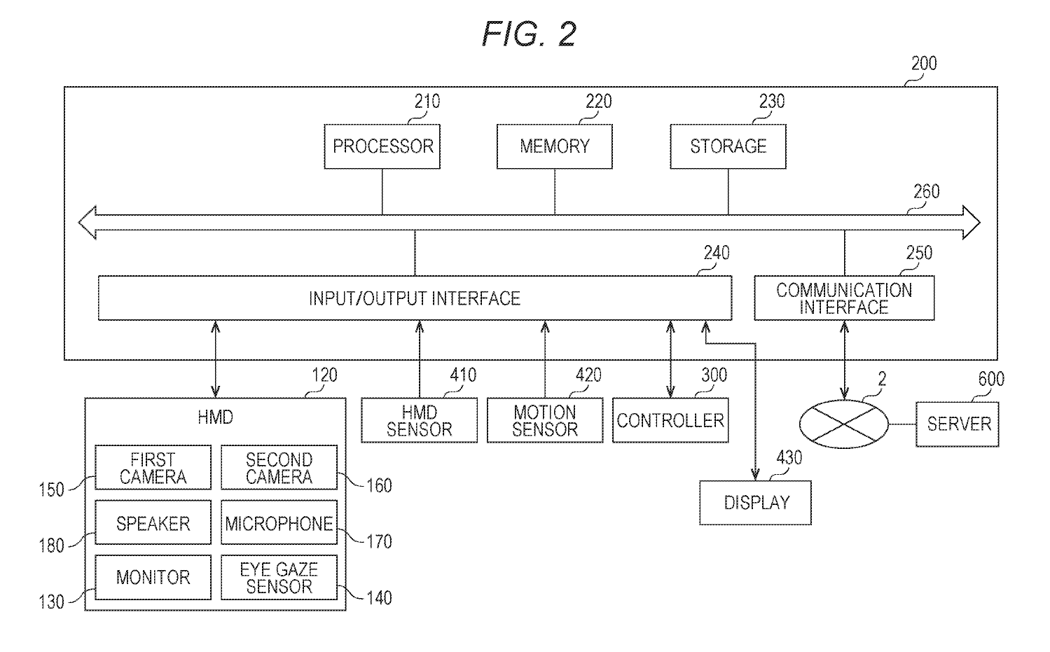

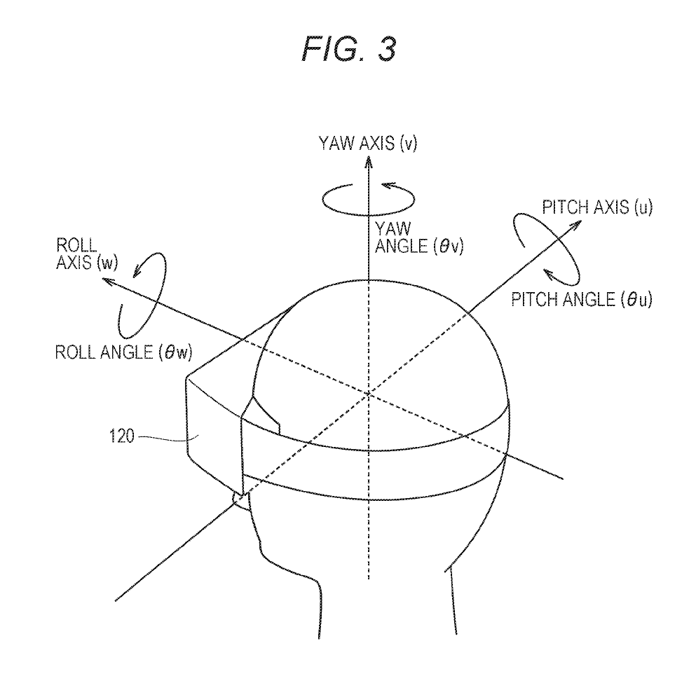

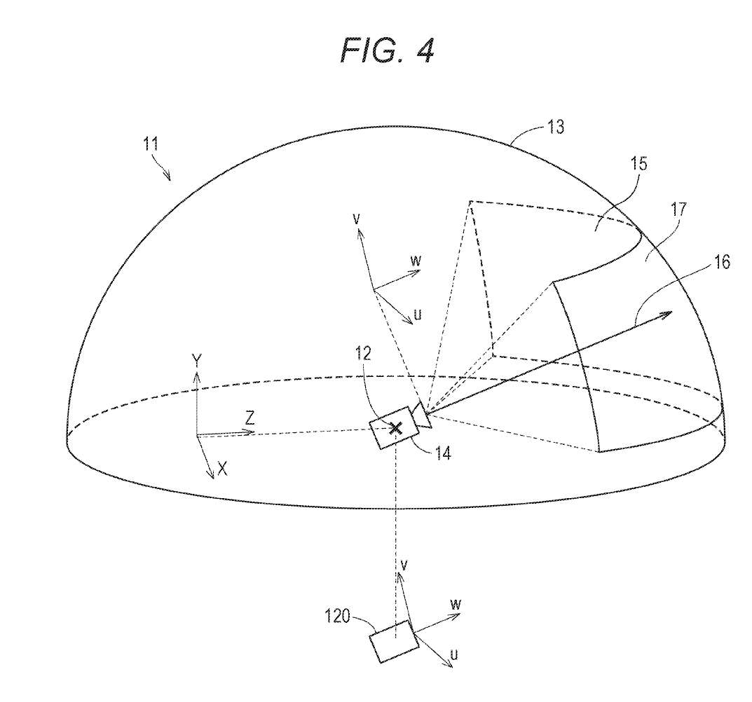

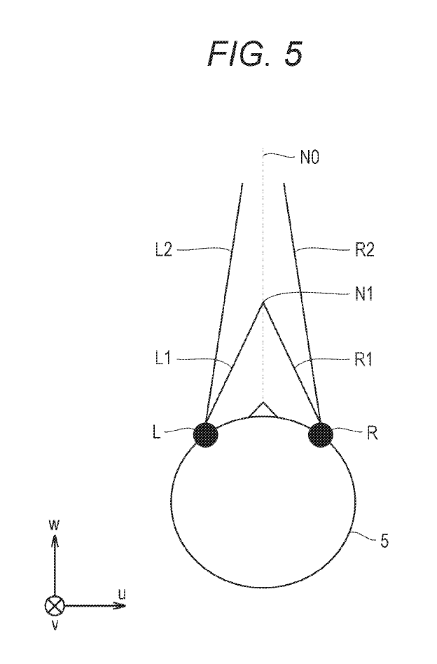

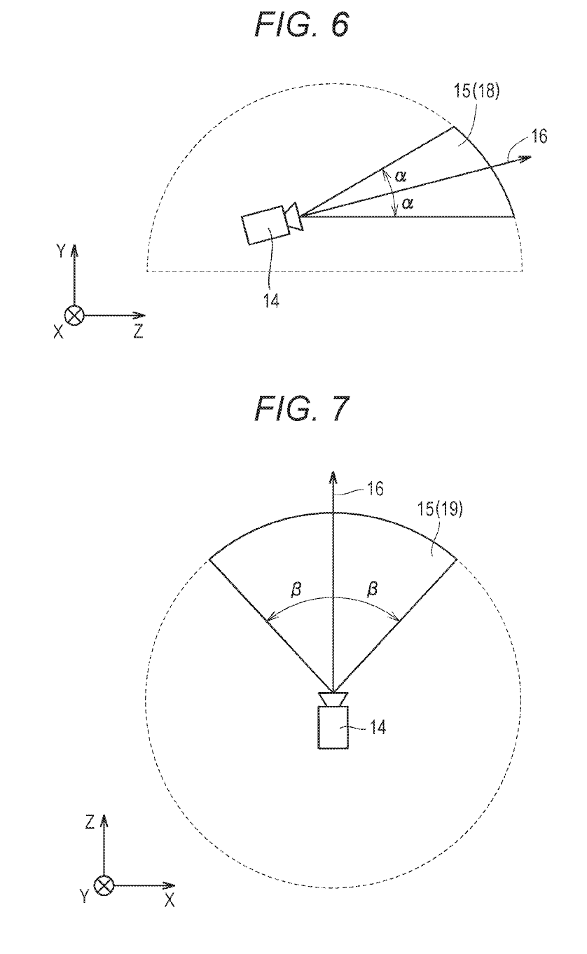

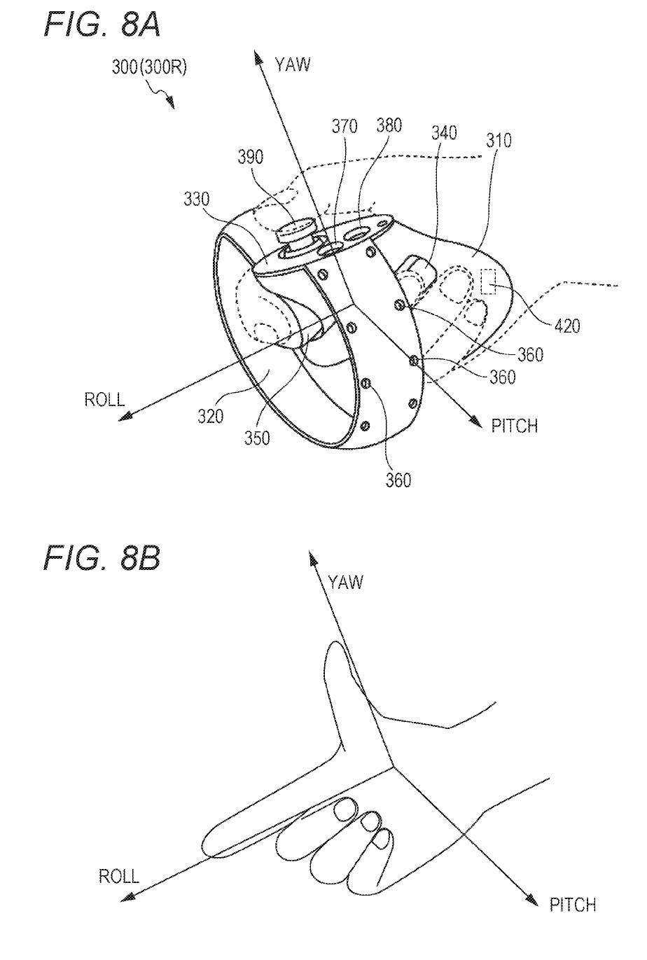

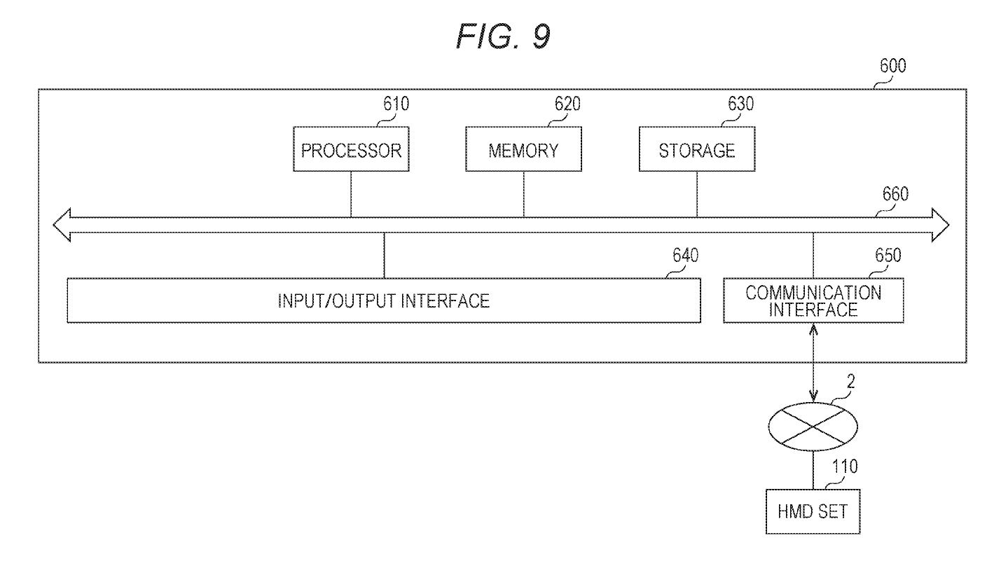

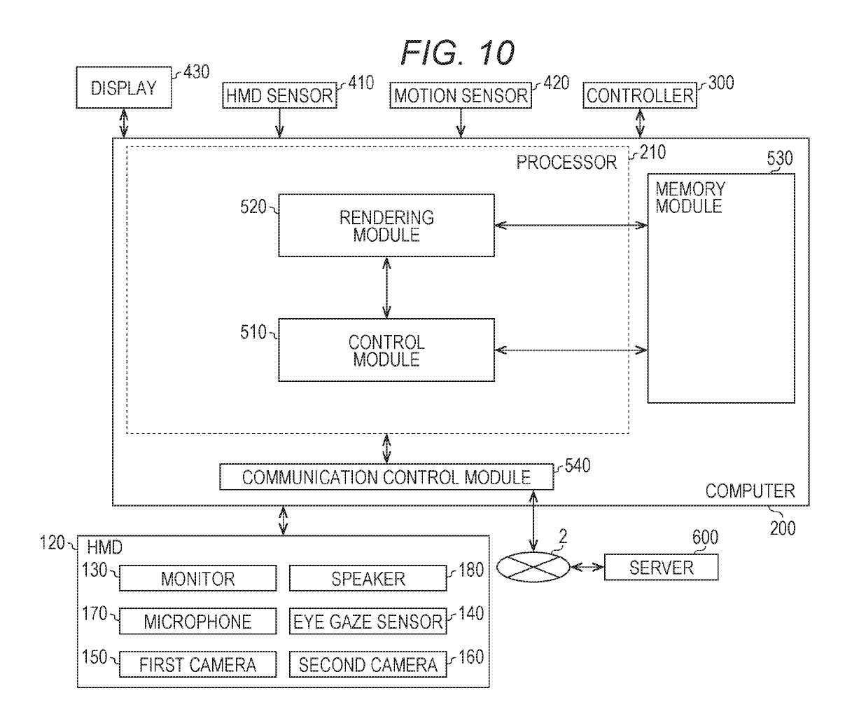

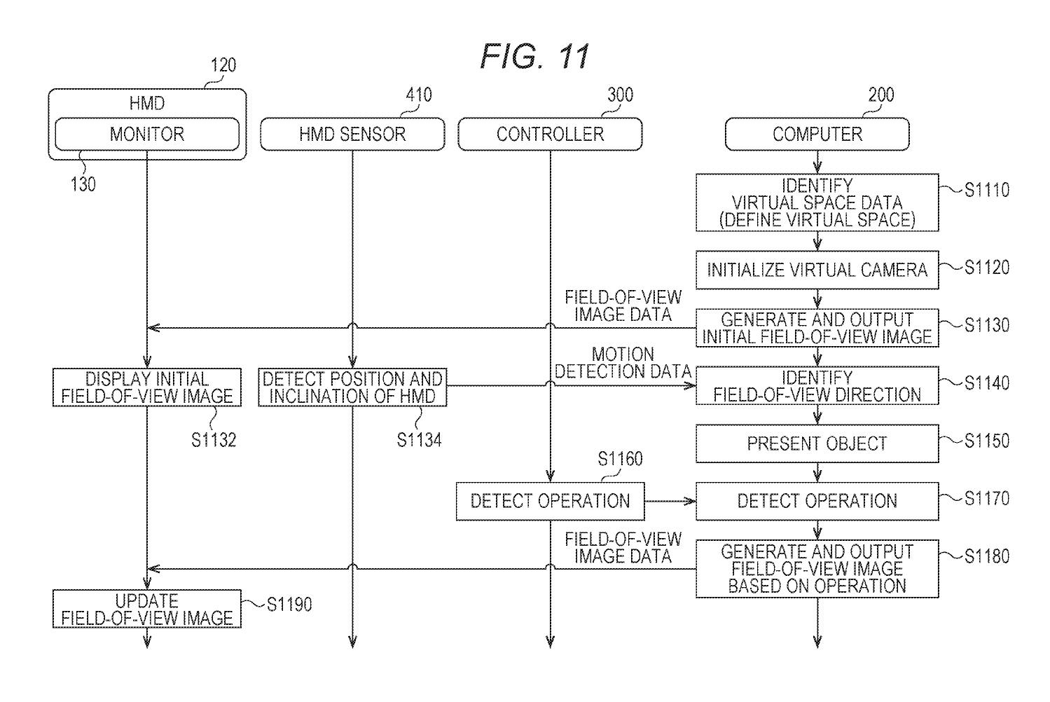

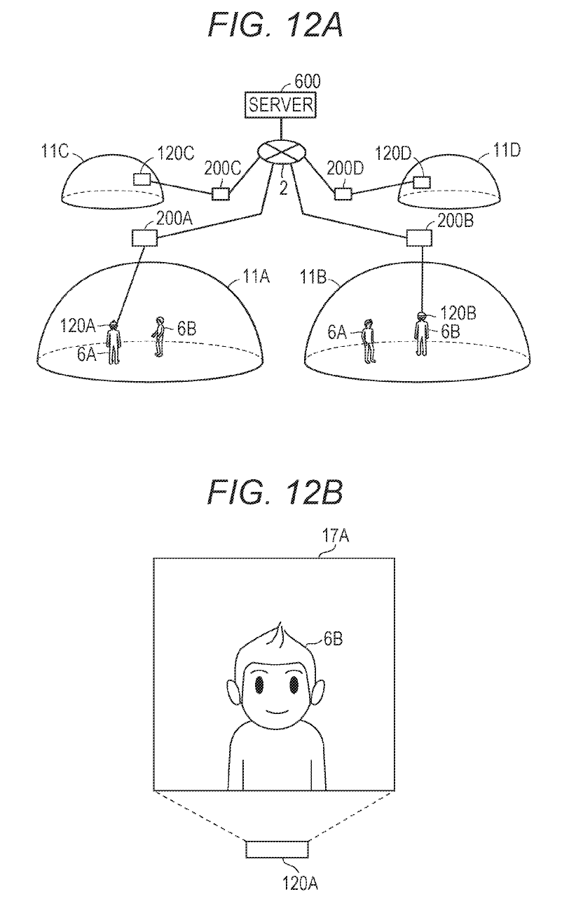

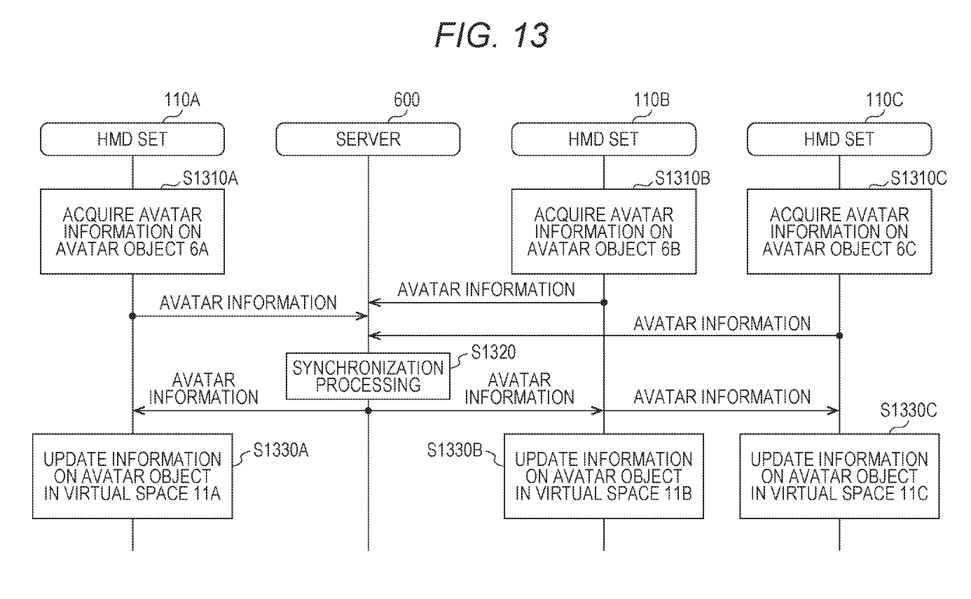

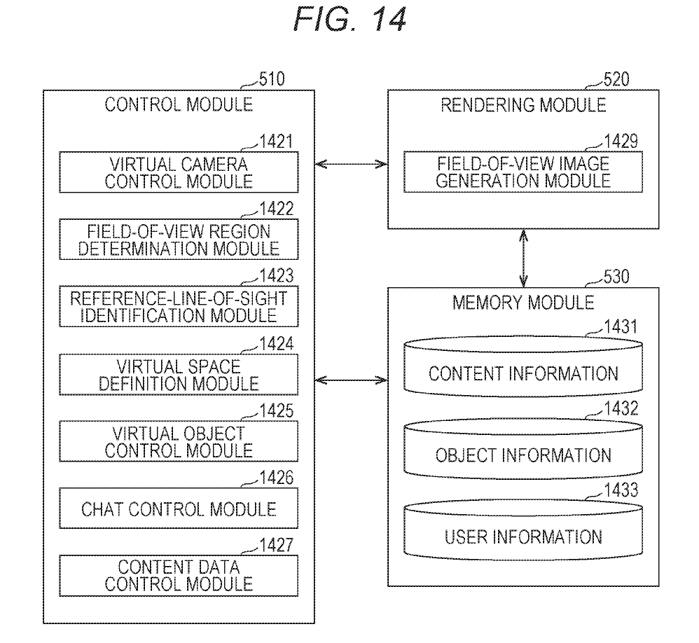

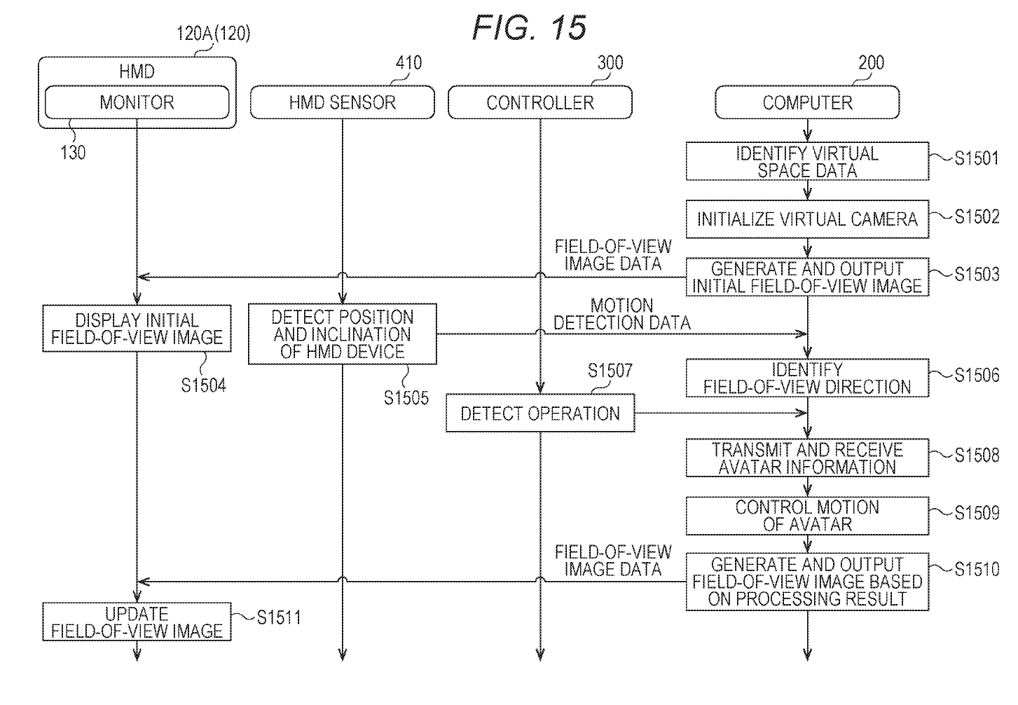

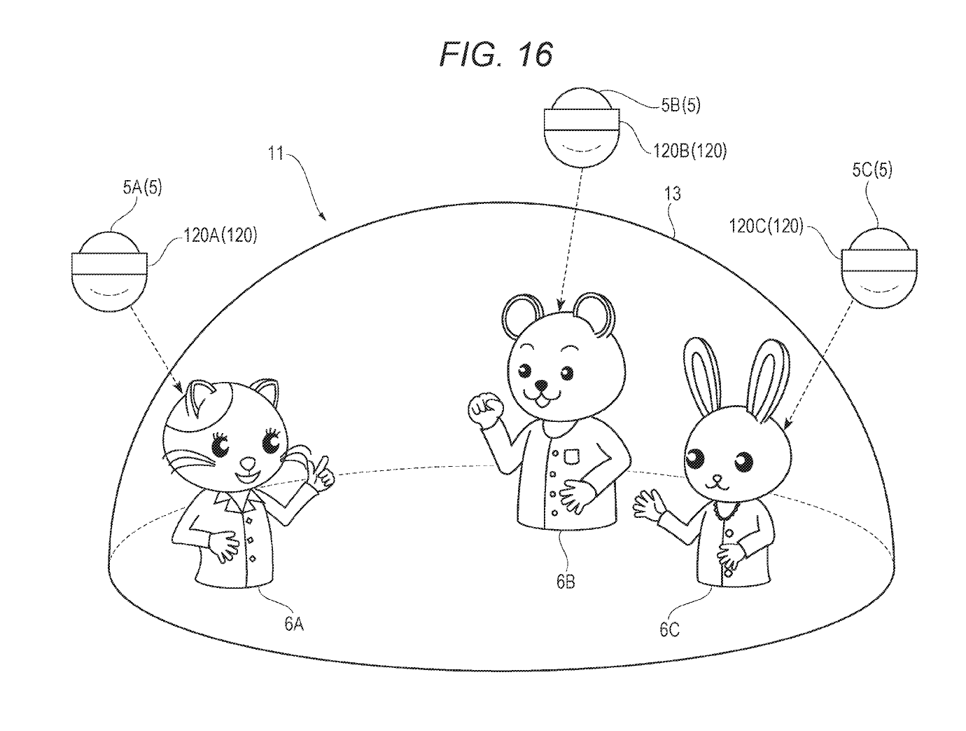

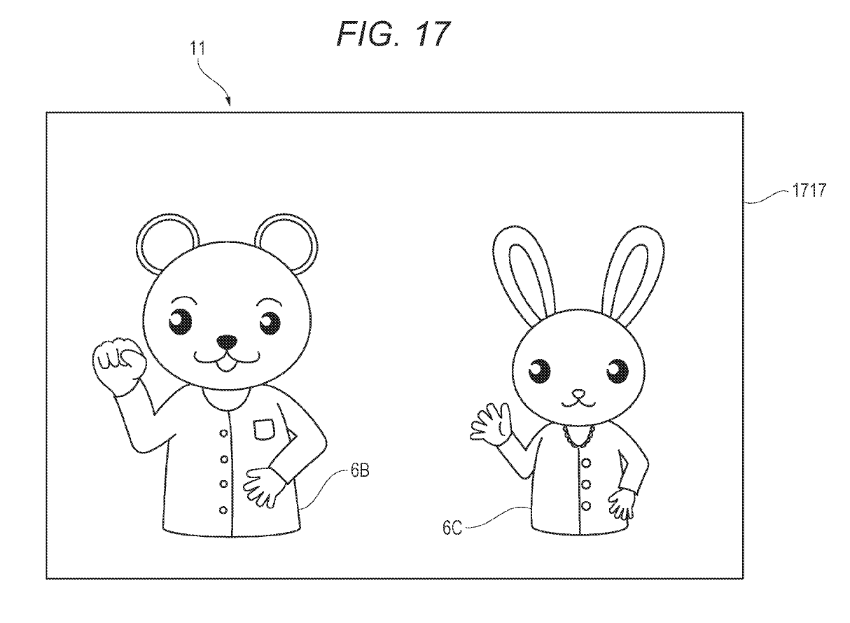

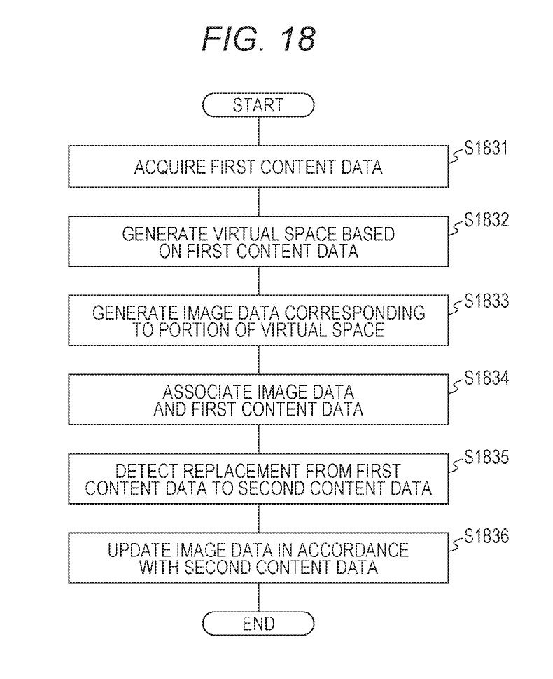

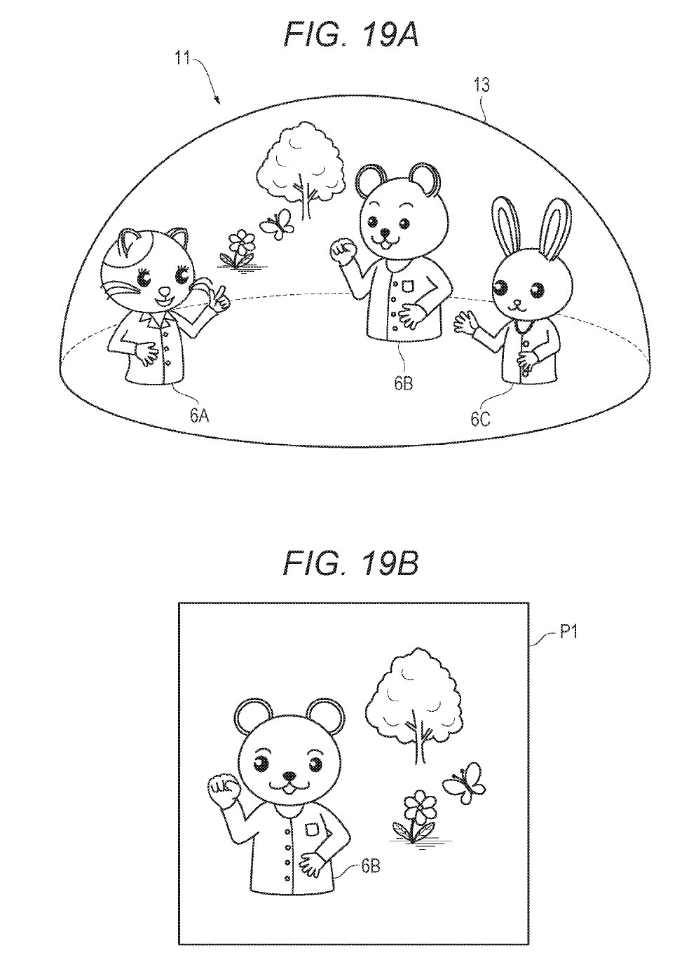

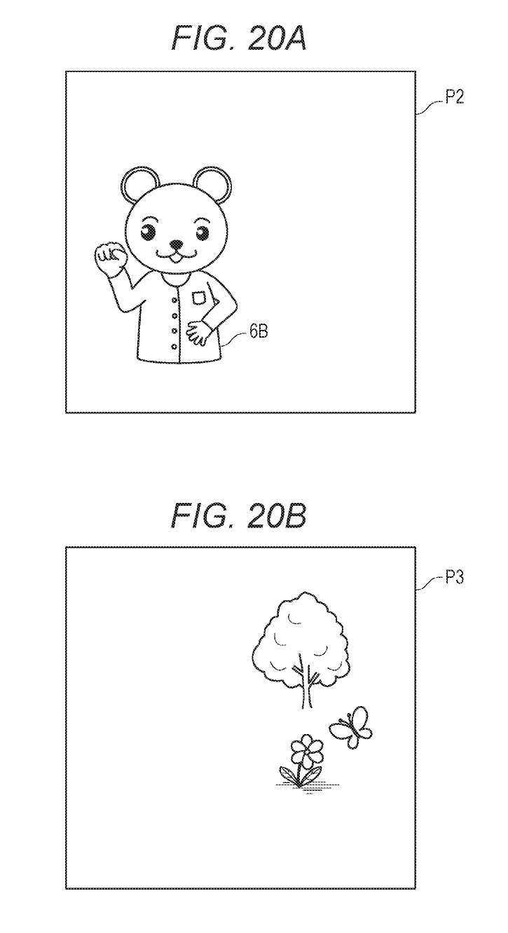

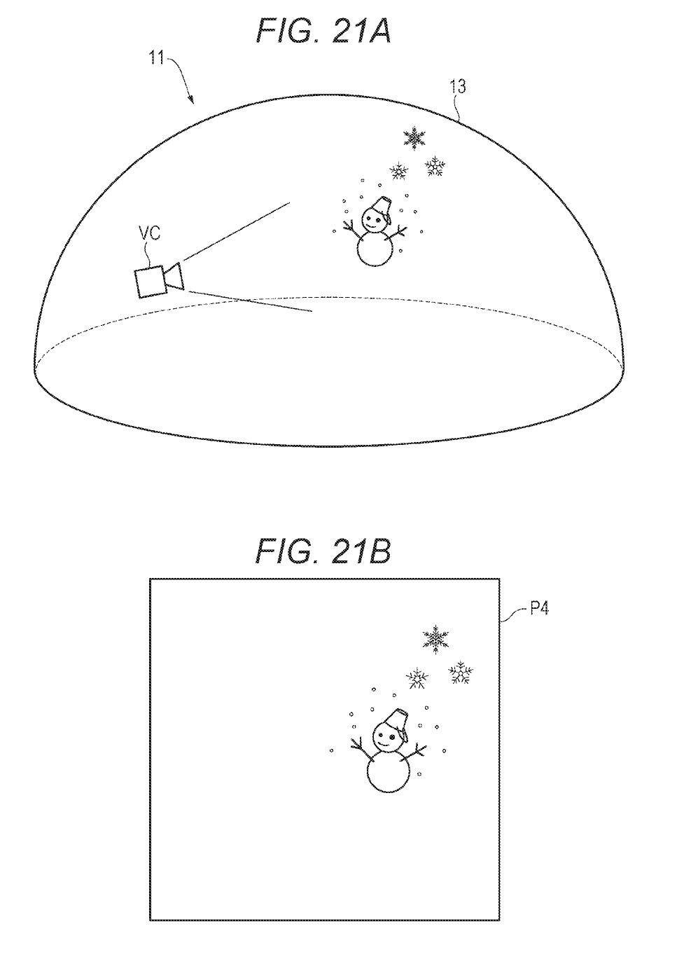

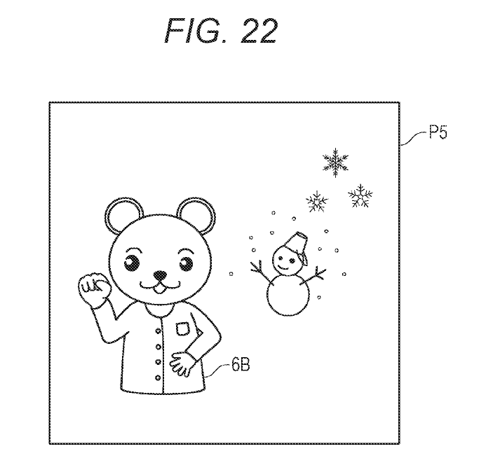

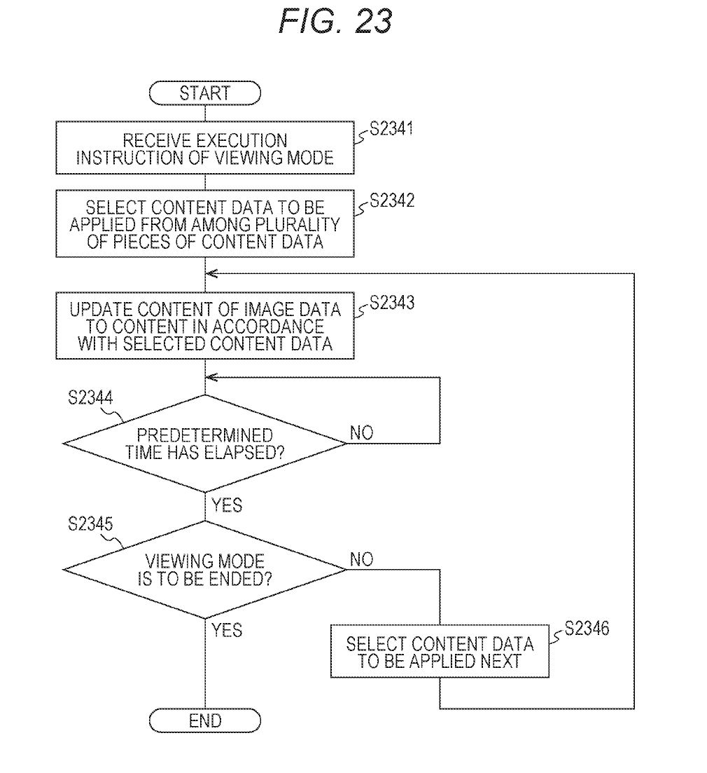

### BRIEF DESCRIPTION OF THE DRAWINGS

[FIG. 1] A diagram of a system including a head-mounted device (HMD) according to at least one embodiment of this disclosure.

[FIG. 2] A block diagram of a hardware configuration of a computer according to at least one embodiment of this disclosure.

[FIG. 3] A diagram of a uvw visual-field coordinate system to be set for an HMD according to at least one embodiment of this disclosure.

[FIG. 4] A diagram of a mode of expressing a virtual space according to at least one embodiment of this disclosure.

[FIG. 5] A diagram of a plan view of a head of a user wearing the HMD according to at least one embodiment of this disclosure.

[FIG. 6] A diagram of a YZ cross section obtained by viewing a field-of-view region from an X direction in the virtual space according to at least one embodiment of this disclosure.

[FIG. 7] A diagram of an XZ cross section obtained by viewing the field-of-view region from a Y direction in the virtual space according to at least one embodiment of this disclosure.

[FIG. 8A] A diagram of a schematic configuration of a controller according to at least one embodiment of this disclosure.

[FIG. 8B] A diagram of a coordinate system to be set for a hand of a user holding the controller according to at least one embodiment of this disclosure.

[FIG. 9] A block diagram of a hardware configuration of a server according to at least one embodiment of this disclosure.

[FIG. 10] A block diagram of a computer according to at least one embodiment of this disclosure.

[FIG. 11] A sequence chart of processing to be executed by a system including an HMD set according to at least one embodiment of this disclosure.

[FIG. 12A] A schematic diagram of HMD systems of several users sharing the virtual space interact using a network according to at least one embodiment of this disclosure.

[FIG. 12B] A diagram of a field of view image of a HMD according to at least one embodiment of this disclosure.

[FIG. 13] A sequence diagram of processing to be executed by a system including an HMD interacting in a network according to at least one embodiment of this disclosure.

[FIG. 14] A block diagram of modules of the computer according to at least one embodiment of this disclosure.

[FIG. 15] A flowchart of processing according to at least one embodiment of this disclosure.

[FIG. 16] A schematic diagram of a virtual space shared by a plurality of users according to at least one embodiment of this disclosure.

[FIG. 17] A diagram of a field-of-view image to be provided to a user according to at least one embodiment of this disclosure.

[FIG. 18] A flowchart of processing relating to generation and update of image data according to at least one embodiment of this disclosure.

[FIG. 19A] A diagram of generation of image data according to at least one embodiment of this disclosure.

[FIG. 19B] A diagram of generation of the image data according to at least one embodiment of this disclosure.

[FIG. 20A] A diagram of a layer image of the image data according to at least one embodiment of this disclosure.

[FIG. 20B] A diagram of a layer image of the image data according to at least one embodiment of this disclosure.

[FIG. 21A] A diagram of updated image data according to at least one embodiment of this disclosure.

[FIG. 21B] A diagram of updated the image data according to at least one embodiment of this disclosure.

[FIG. 22] A diagram of updated image data according to at least one embodiment of this disclosure.

[FIG. 23] A flowchart of a processing procedure performed during a viewing mode according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth (R), near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-field Coordinate System]

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle a from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIGS. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity (R) provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step 51160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step 51310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Module Configuration]

With reference to FIG. 14, a module configuration of the computer 200 are described. FIG. 14 is a block diagram of modules of the computer 200 according to at least one embodiment of this disclosure.

In FIG. 14, the control module 510 includes a virtual camera control module 1421, a field-of-view region determination module 1422, a reference-line-of-sight identification module 1423, a virtual space definition module 1424, a virtual object control module 1425, a chat control module 1426, and a content data control module 1427. The rendering module 520 includes a field-of-view image generation module 1429. The memory module 530 stores content information 1431, object information 1432, and user information 1433.

In at least one aspect, the control module 510 controls display of an image on the monitor 130 of the HMD 120. The virtual camera control module 1421 arranges the virtual camera 14 in the virtual space 11, and controls, for example, the behavior and direction of the virtual camera 14. The field-of-view region determination module 1422 defines the field-of-view region 15 in accordance with the direction of the head of the user wearing the HMD 120. The field-of-view image generation module 1429 generates a field-of-view image to be displayed on the monitor 130 based on the determined field-of-view region 15. The reference-line-of-sight identification module 1423 identifies the line of sight of the user 5 based on the signal from the eye gaze sensor 140.

The control module 510 controls the virtual space 11 to be provided to the user 5. The virtual space definition module 1424 generates virtual space data representing the virtual space 11, to thereby define the virtual space 11 in the HMD set 110.

The virtual object control module 1425 generates a virtual object, which is a virtual object to be arranged in the virtual space 11, based on the object information 1432 to be described later. The virtual object control module 1425 also controls motion (e.g., movement and state change) of the virtual object in the virtual space 11.

The virtual object is any object to be arranged in the virtual space 11. The virtual object maybe, for example, an animal or scenery including forests, mountains, and the like, to be arranged in accordance with the progress of the game story. The virtual object may also be an avatar, which is an alter-ego of the user in the virtual space, or a character object such as a character (player character) in the game operated by the user. The virtual object may also be an operation object, which is an object that moves in accordance with the movement of a part (e.g., hand) of the body of the user 5. For example, the operation object may include a hand object corresponding to the hand of the user 5 wearing the HMD 120, a finger object corresponding to a finger of the user 5, and the like. An object operated in association with the hand object may also function as an operation object that moves in accordance with motion of the hand of the user 5. For example, a stick-like object grasped by the hand object, such as a touch pen, may function as the operation object. In the following description, when there is no fear of misunderstanding, the virtual object is simply referred to as “object”.

The chat control module 1426 performs control for chatting with the avatar of another user staying in the same virtual space 11. For example, the chat control module 1426 transmits data required for chatting via the virtual space 11 (e.g., sound data input to microphone 170) to the server 600. The chat control module 1426 outputs the sound data of another user received from the server 600 to a speaker (not shown). As a result, sound-based chat is implemented. The chat control module 1426 transmits and receives the data to be shared among other users to and from the HMD set 110 of the other users via the server 600. The data to be shared is, for example, motion detection information for controlling a motion of a part of the body of the avatar.

The motion detection data is, for example, direction data, eye tracking data, face tracking data, and hand tracking data. The direction data is information indicating the position and inclination of the HMD 120 detected by the HMD sensor 410 and the like. The eye tracking data is information indicating the line-of-sight direction detected by the eye gaze sensor 140 and the like. The face tracking data is data generated by image analysis processing on image information acquired by the second camera 160 of the HMD 120A, for example. The face tracking data is information indicating a temporal change in the position and the size of each part of the face of the user 5A. The hand tracking data is, for example, information indicating motion of the hand of the user 5A detected by the motion sensor 420 and the like.

In at least one embodiment, the chat control module 1426 transmits and receives information including sound data and motion detection data (hereinafter referred to as “avatar information”) as information to be shared among the users, to and from the HMD set 110 of another user via the server 600. The avatar information is transmitted and received by utilizing the function of the communication control module 540.

The content data control module 1427 generates image data associated with the content data for defining the virtual space 11, and updates the image data when the content data to be applied in the virtual space 11 has been replaced. The image data may be a two-dimensional image or a three-dimensional image. The content data is data forming a portion of the above-mentioned virtual space data. The content data and the processing by the content data control module 1427 are described in more detail later.

When any of the objects arranged in the virtual space 11 has collided with another object, the control module 510 detects that collision. The control module 510 can detect, for example, the timing of a given object touching another object, and performs processing determined in advance when the timing is detected. The control module 510 can detect the timing at which objects that are touching each other separate from each other, and performs processing determined in advance when the timing is detected. The control module 510 can also detect a state in which objects are touching each other by, for example, executing a known hit determination based on a collision area set for each object.

The content information 1431 includes, for example, content to be played back in the virtual space 11 and information for arranging an object to be used in that content. Examples of the content may include a game and content representing scenery similar to that of the real world. Specifically, the content information 1431 may include virtual space image data (panorama image 13) defining a background of the virtual space 11 and definition information on an object arranged in the virtual space 11. The definition information on the object may include rendering information for rendering the object (e.g., information representing a design such as a shape and color of the object), information indicating an initial arrangement of the object, and the like. The definition information on an object autonomously moving based on a motion pattern set in advance may include information (e.g., program) indicating the motion pattern. An example of a motion based on a motion pattern determined in advance is a simple repetitive motion like a motion in which an object imitating grass sways in a certain pattern.

The object information 1432 includes information indicating the state of each object arranged in the virtual space 11 (state that may change in accordance with the progress of the game and operations by the user 5, for example). Specifically, the object information 1432 may include position information indicating the position of each object (e.g., position of center of gravity set for an object). The object information 1432 may further include motion information indicating a motion of a deformable object (i.e., information for identifying the shape of the object). Examples of a deformable object include objects that, like the avatar described above, have a part such as a head, a torso, and hands, and that can independently move each part in accordance with a motion of the user 5.

The user information 1433 includes, for example, a program for causing the computer 200 to function as the control device for the HMD set 110 and an application program that uses each piece of content stored in the content information 1431.

[Control Structure]

With reference to FIG. 15, the control structure of the computer 200 according to at least one embodiment of this disclosure is described. FIG. 15 is a flowchart of processing to be executed by the HMD set 110A, which is used by the user 5A, to provide the virtual space 11 to the user 5A according to at least one embodiment of this disclosure. Similar processing is also executed by the other HMD sets 110B and 110C.

In Step S1501, the processor 210 of the computer 200 serves as the virtual space definition module 1424 to identify the virtual space image data (panoramic image 13) forming the background of the virtual space 11, and define the virtual space 11.

In Step S1502, the processor 210 serves as the virtual camera control module 1421 to initialize the virtual camera 14. For example, in a work area of the memory, the processor 210 arranges the virtual camera 14 at the center defined in advance in the virtual space 11, and matches the line of sight of the virtual camera 14 with the direction in which the user 5 faces.

In Step S1503, the processor 210 serves as the field-of-view image generation module 1429 to generate field-of-view image data for displaying an initial field-of-view image. The generated field-of-view image data is transmitted to the HMD 120 by the communication control module 540 via the field-of-view image generation module 1429.

In Step S1504, the monitor 130 of the HMD 120 displays a field-of-view image based on a signal received from the computer 200. The user 5A wearing the HMD 120A may recognize the virtual space 11 through visual recognition of the field-of-view image.

In Step S1505, the HMD sensor 410 detects the position and inclination of the HMD 120 based on a plurality of infrared rays emitted from the HMD 120. The detection results are transmitted to the computer 200 as motion detection data.

In Step S1506, the processor 210 serves as the field-of-view region determination module 1422 to identify, based on the position and inclination of the HMD 120A, the field-of-view direction of the user 5A wearing the HMD 120A (i.e., position and inclination of virtual camera 14). The processor 210 executes the application program and arranges the object in the virtual space 11 based on a command included in the application program.

In Step S1507, the controller 300 detects an operation performed by the user 5A in the real space. For example, in at least one aspect, the controller 300 detects that a button has been pressed by the user 5A. In at least one aspect, the controller 300 detects a motion of both hands of the user 5A (e.g., waving both hands). A signal indicating details of the detection is transmitted to the computer 200.

In Step S1508, the processor 210 serves as the chat control module 1426 to transmit and receive avatar information to and from another HMD set 110 (in this example, HMD sets 110B and 110C) via the server 600.

In Step S1509, the processor 210 serves as the virtual object control module 1425 to control a motion of the avatar associated with each user based on the avatar information on each user 5.

In Step S1510, the processor 210 serves as the field-of-view image generating module 1429 to generate field-of-view image data for displaying a field-of-view image based on the result of the processing in Step S1509, and output the generated field-of-view image data to the HMD 120.

In Step S1511, the monitor 130 of the HMD 120 updates a field-of-view image based on the received field-of-view image data, and displays the updated field-of-view image.

The processing of Step S1505 to Step S1511 is periodically repeatedly executed.

FIG. 16 is a schematic diagram of the virtual space 11 shared by a plurality of users according to at least one embodiment of this disclosure. In FIG. 16, the avatar 6A associated with the user 5A wearing the HMD 120A, the avatar 6B associated with the user 5B wearing the HMD 120B, and the avatar 6C associated with the user 5C wearing the HMD 120C are arranged in the same virtual space 11. In such a virtual space 11 shared by a plurality of users, a communication experience, for example, chat with other users via the avatars 6A to 6C, can be provided to each user.

In this example, each of the avatars 6A to 6C is defined as a character object imitating an animal (cat, bear, or rabbit). The avatars 6A to 6C include, as parts capable of moving in association with a motion of a user, a head (face direction), eyes (e.g., line of sight and blinking), a face (facial expression), and hands. The head is a part that moves in association with a motion of the HMD 120 detected by the HMD sensor 410 or the like. The eyes are a part that moves in association with the motion and change in line of sight of the eyes of a user detected by the second camera 160 and the eye gaze sensor 140 or the like. The face is a part in which a facial expression determined based on face tracking data, which is described later, is translated. The hands are parts that move in association with the motion of the hands of the user detected by the motion sensor 420 or the like. The avatars 6A to 6C each include a body portion and arm portions displayed in association with the head and the hands. Motion control of legs lower than hips is complicated, and hence the avatars 6A to 6C do not include legs.

The visual field of the avatar 6A matches the visual field of the virtual camera 14 in the HMD set 110A. As a result, a field-of-view image 1717 in a first-person perspective of the avatar 6A is provided to the user 5A. More specifically, a virtual experience as if the user 5A were present as the avatar 6A in the virtual space 11 is provided to the user 5A. FIG. 17 is a diagram of the field-of-view image 1717 to be provided to the user 5A via the HMD 120A according to at least one embodiment of this disclosure. A field-of-view image in a first-person perspective of each of the avatars 6B and 6C is similarly provided to each of the users 5B and 5C.

[Generation and Update of Image Data]

The processing procedures relating to generation and update of the image data are now described with reference to FIG. 18. The image data is image data corresponding to a portion of the virtual space 11. The image data may be a two-dimensional image or a three-dimensional image. Similarly to the field-of-view image data provided to the user 5, the image data is defined by the field-of-view region that is based on the viewpoint information set in the virtual space 11. The viewpoint information is information for identifying the field-of-view region in the virtual space 11, and is information indicating the position and inclination in the virtual space 11, for example. The information indicating the position and inclination of the virtual camera 14 is one type of viewpoint information. The image data is, for example, a still image of the state of the virtual space 11 at a predetermined point in time (e.g., point designated by user 5A). The processing of Step S1831 and Step S1832 corresponds to the processing of Step S1501 of FIG. 15, and is executed by the virtual space definition module 1424. The processing of Step S1833 to Step S1836 is executed by the content data control module 1427.

In Step S1831, the processor 210 of the HMD set 110A (hereinafter simply referred to as “processor 210”) acquires the content data for defining the virtual space 11.

The content data is data forming a portion of the virtual space data. In at least one embodiment, for example, the content data is included in the above-mentioned content information 1431. More specifically, the content data is, for example, data in which content (background data) developed as the panorama image 13 is recorded. The content data is delivered to the HMD set 110A from a computer (hereinafter referred to as “content distribution platform”) operated by an operator who provides (distributes) the above-mentioned content (e.g., content representing scenery in real world). For example, the server 600 may form the content distribution platform. In at least one embodiment, as one example, the content data (first content data) acquired in Step S1831 is video content (e.g., video content of spring scenery) recording scenery of the four seasons photographed by a fixed point camera (e.g., 360-degree camera) installed at a place having a good view.

In Step S1832, the processor 210 generates the virtual space 11 based on the first content data. Specifically, the processor 210 generates the virtual space 11 in which the first content data is developed as the panorama image 13.

In Step S1833, the processor 210 generates, when a condition determined in advance is established, image data corresponding to a portion of the virtual space 11. The image data may be generated based on a portion of the virtual space 11 designated by the user 5A while the virtual experience is being provided to the user 5A (i.e., while user 5A is viewing the virtual space 11 via avatar 6A). For example, the processor 210 generates the image data when an input operation determined in advance is received by the controller 300, a user operation on a menu screen displayed in the field-of-view image is received, and the like.

For example, the processor 210 receives from the user 5A information indicating the photography region in the virtual space 11. The information indicating the photography region is information for identifying a region similar to the field-of-view region 15 in FIG. 6 and FIG. 7, for example, and is information on the position, direction, polar angle, azimuth angle, and the like in the virtual space 11. When using the same polar angle and azimuth angle as the polar angle a and azimuth angle β of the field-of-view region 15, the processor 210 may acquire only the viewpoint information indicating the position and direction (inclination) in the virtual space 11 from the user 5A. Next, the processor 210 generates image data corresponding to a portion in which the photography region and the virtual space 11 overlap. The image data is generated by the same processing as the processing for determining the field-of-view image data to be provided to the user 5A based on the field-of-view region 15.

The image data may be generated based on the viewpoint information defining the field-of-view image. In other words, the processor 210 may set the field-of-view region 15 that is based on the position and inclination of the virtual camera 14 as the photography region, and generate the image data based on the set photography region. In this case, the same image as the field-of-view image provided to the user 5A is generated as the image data. More specifically, when the user 5A (avatar 6A) viewing the content (panorama image 13) in the virtual space 11 executes a photography operation determined in advance, the field-of-view image seen from the user 5A is generated as the image data. The photography operation determined in advance is, for example, an input operation to the controller 300, an operation of touching an icon object or the like included in the field-of-view image with a hand object, and the like.

The virtual space 11 may include an operation object associated with the user 5A and a photography object operated by the operation object. The operation object is, for example, the above-mentioned hand object or the like. The photography object is, for example, an object imitating a camera or the like, and is an object having a function of photographing (image capturing) in the virtual space 11. In this case, the image data may be generated based on the viewpoint information associated with the photography object. Specifically, the processor 210 may set the photography region based on the position and inclination of the photography object, and generate the image data based on the set photography region. In this case, the user 5A is provided with an experience as if the virtual space 11 has been photographed by a camera. The timing (photography timing) at which the image data is generated may be set to the timing at which the photography object receives the input operation by the operation object. The input operation is, for example, an operation of touching a photography button provided on the photography object by the operation object. In this case, the image data is generated based on the viewpoint information (position and inclination of photography object) at the timing when the photography object received the input operation.

The image data generated in Step S1833 includes a first portion corresponding to the avatar (character object) associated with the user and a second portion dependent on the content data to be applied. For example, the image data includes constituent elements (e.g., objects and panorama image 13) of the virtual space 11 included in the portion at which the virtual space 11 and the photography region overlap (three-dimensional region) as layer images different from each other. Specifically, in the image data, layers are defined in accordance with an overlapping order from the panorama image 13, which corresponds to the portion arranged at the very back, to the object arranged at the very front, and images (layer images) corresponding to each layer are included in the image data. Definition information is associated with the image data, and indicates which of the first portion and the second portion each layer image corresponds to. In at least one embodiment, a background image (panorama image 13) that changes in accordance with the type of the content data to be applied is defined as the second portion, and a portion corresponding to the avatar is defined as the first portion.

An example of the processing of Step S1832 and Step S1833 is now described with reference to FIG. 19A, FIG. 19B, FIG. 20A, and FIG. 20B. In FIG. 19A, there is the virtual space 11 generated in Step S1832. The video content of spring scenery recorded as the first content data is displayed as the panorama image 13. In FIG. 19B, there is image data P1 generated in Step S1833. As in FIG. 20A and FIG. 20B, the image data P1 includes, as the first portion, a layer image P2 including a portion corresponding to the avatar 6B, and as the second portion, a layer image P3 corresponding to the panorama image 13.

The image data P1 may be generated as a fixed object at a predetermined position in the virtual space 11 or may be generated as a movable object capable of being moved in the virtual space 11. For example, the image data P1 may be generated as a portable object imitating a photograph in the real world. In this case, for example, the image data P1 is able to be shared among a plurality of users. The image data P1 may be displayed and output on a display included in a terminal device different from the HMD 120. The image data P1 may be transferred to the terminal device via, for example, the Internet. The terminal device is, for example, a desktop PC, a laptop PC, a mobile terminal (e.g., smartphone or tablet terminal), or the like possessed by the user 5A. In this case, the image data photographed in the virtual space 11 is viewable in the real space. The image data P1 may also be uploaded to another system (e.g., social networking service (SNS) site) via the Internet or the like. In this case, image data P1 photographed in the virtual space 11 is able to be posted to an SNS site and the like, which enables a past experience in the virtual space 11 to be shared and enjoyed with other users in the real space.

In Step S1834, the processor 210 associates the image data P1 with the first content data. The association may be performed by known processing relating to data association.

In Step S1835, the processor 210 detects a replacement from the first content data to the second content data. For example, when new content data (second content data) is distributed from the content distribution platform to the HMD set 110A, the processor 210 applies the new content data in the virtual space 11 (Step S1831 and Step S1832), and detects that the content data has been replaced.

The content delivery platform may be set to distribute video content that is associated with, for example, time in the real world to the HMD set 110A at a timing determined in advance. For example, at a time determined in advance set as a change in the seasons, content data corresponding to the next season may be delivered as new content data. The content distribution platform may also obtain content data in which scenery photographed by a fixed point camera at times of day such as the morning, daytime, and nighttime is recorded, and deliver each piece of the content data during the corresponding time of day.

A plurality of pieces of content data may be stored in the memory module 530 in advance. In this case, in place of replacing the content data to be applied in the virtual space 11 when the new content data is distributed from the content distribution platform, the processor 210 may replace the content data when a period or time determined in advance is reached.

In Step S1836, when the replacement from the first content data to the second content data (in at least one embodiment, video content of winter scenery) is detected, the processor 210 updates the content of the image data P1 associated with the first content data to the content corresponding to the second content data. For example, the processor 210 generates update image data corresponding to an overlapping portion between the photography region used when generating the image data P1 in Step S1833 and the virtual space 11 (virtual space 11 in which avatar 6B is not present) in which the second content data has been applied. The update image data is a layer image (panorama image 13 corresponding to second content data) corresponding to the layer image P3, which is the second portion of the image data P1. Next, the processor 210 updates the layer image P3 to the update image data corresponding to the second content data.

The processor 210 may change the display mode of the avatar 6B, which is the first portion of the image data P1, based on the second content data. For example, the processor 210 may adjust the display mode (e.g., brightness (luminance) and color such as hue) of the avatar 6B based on an attribute (e.g., season information) associated in advance with the second content data. For example, the processor 210 may set the hue of the avatar 6B to be brighter in the case of summer scenery in which the sunlight is strong, and adjust the hue of the avatar 6B to be darker in the case of winter scenery, in which the sunlight is weak. In the case of summer scenery, the processor 210 may perform processing for superimposing an effect image representing sweat on the face of the avatar 6B. In this way, image data in which the first portion and the second portion after replacement are consistent with each other may be obtained by changing not only the display mode of the second portion but also the display mode of the first portion in accordance with the content of the content data.

An example of the processing of Step S1836 is now described with reference to FIG. 21A, FIG. 21B, and FIG. 22. FIG. 21A is a schematic diagram of processing for acquiring the update image data according to at least one embodiment of this disclosure. Specifically, in FIG. 21A, there is a state in which update image data is obtained by photographing the interior of the virtual space 11 in which the second content data has been applied by a photography virtual camera VC with which the photography region used for generating the image data P1 is associated. In FIG. 21B, there is update image data P4 obtained in this way. In FIG. 22, there is updated image data P5 obtained by replacing the layer image P3 of the image data P1 with the update image data P4.

[Viewing Mode]

Next, the viewing mode implemented by the above-mentioned image data is now described. The viewing mode is a mode in which the background of the image data is sequentially switched by sequentially switching the content data applied in the virtual space 11 from among the plurality of pieces of content data. For example, changes over time (e.g., changes over 10 years) in a predetermined place may be viewed by the user 5 by chronologically switching the scenery of the image data associated with the scenery (content data) of the predetermined place observed from a fixed point at a speed faster than the actual flow of time. In this way, the virtual experience of the user 5 using the image data may be enriched. The viewing mode is implemented, for example, as follows. Specifically, in response to a request from the user 5, the processor 210 sequentially updates the content corresponding to the content data in which the content of the image data is applied, while switching the content data to be applied in the virtual space 11 from among the plurality of pieces of content data in an order determined in advance.

A processing procedure for executing the viewing mode is now described with reference to FIG. 23.

In Step S2341, the processor 210 detects establishment of a condition determined in advance. For example, when an execution instruction of the viewing mode is received from the user 5, the processor 210 determines that the above-mentioned condition is established. The execution instruction is output from the controller 300 to the processor 210 when, for example, an operation determined in advance is input to the controller 300.

In Step S2342, the processor 210 selects the content data to be applied in the virtual space 11 from among the plurality of pieces of content data. As an example, the point in time (e.g., date and time) at which the scenery is observed is associated with the plurality of pieces of content data. The processor 210 then selects the content data corresponding to the scenery observed at the earliest time among the plurality of pieces of content data as the content data to be applied in the virtual space 11.

In Step S2343, the processor 210 updates the content of the image data in accordance with the selected content data. This update is implemented by the same processing as the above-mentioned Step S1836.

In Step S2344, the processor 210 monitors whether or not a predetermined time has elapsed as a time interval for switching the content data. In response to a detection that the predetermined time has elapsed, in Step S2345, the processor 210 determines whether or not to end the viewing mode. The determination of whether or not to end the viewing mode is carried out based on, for example, whether or not there is next content data (i.e., content data later in chronological order than currently applied content mode). When there is no next content data, the processor 210 determines that the viewing mode is to be ended (Step S2345: YES), and ends the processing.

On the other hand, when there is next content data, the processor 210 determines that the viewing mode is to be continued (Step S2345: N0), and in Step S2346, the processor 210 selects the next content data in chronological order as the content data to be applied next, and returns the processing to Step S2343.

With the generation and update of the image data described above, the portion (background portion in at least one embodiment) corresponding to the content data of the image data generated at a certain point in time can be changed in accordance with the replacement of the content data. For example, when the image data generated in the virtual space 11 is able to be uploaded to an SNS or the like as described above, the user may set image data including his or her own avatar as the profile image for the user in the SNS site. Then, when the content data applied in the virtual space 11 is changed, the background of the profile image is also automatically updated. For example, when the content data applied in the virtual space 11 is to be changed in accordance with the seasons in the real world, the background of the profile image is also changed in accordance with the seasons as well, and hence the profile image may be provided with a seasonal feeling. As described above, with the embodiment described above, the user is provided with both a mechanism capable of photographing and storing an image obtained by simply cutting out a portion of the virtual space 11, and also with an enjoyment style that is only possible because the virtual space 11 is a virtual space. As a result, the entertainment value of the virtual experience of the user 5 may be improved.

This concludes descriptions of at least one embodiment of this disclosure. However, the descriptions of at least one embodiment are not to be read as a restrictive interpretation of the technical scope of this disclosure. At least one embodiment is merely given as an example, and a person skilled in the art would understand that various modifications can be made to at least one embodiment within the scope of this disclosure set forth in the appended claims. The technical scope of this disclosure is to be defined based on the scope of this disclosure set forth in the appended claims and an equivalent scope thereof.

For example, each process described as being executed by the processor 210 of the HMD set 110 in at least one embodiment may be executed by a processor included in the server 600 or in a distributed manner by the processor 210 and the server 600.

In at least one embodiment, the description is given by exemplifying the virtual space (VR space) in which the user 5 is immersed through use of the HMD 120. However, a see-through HMD device may be adopted as the HMD 120. In this case, the user 5 may be provided with a virtual experience in an augmented reality (AR) space or a mixed reality (MR) space through output of a field-of-view image that is a combination of the real space visually recognized by the user 5 via the see-through HMD device and a portion of an image forming the virtual space. In this case, an action may be exerted on a target object (e.g., photography object) in the virtual space 11 based on a motion of a hand of the user 5 in the real space instead of the operation object (e.g., hand object) in the virtual space 11. Specifically, the processor 210 may identify coordinate information on the position of the hand of the user 5 in the real space, and define the position of the target object in the virtual space 11 based on the relationship with the coordinate information in the real space. With this, the processor 210 can grasp the positional relationship between the hand of the user 5 in the real space and the target object in the virtual space 11, and execute processing corresponding to, for example, the above-mentioned hit determination between the hand of the user 5 and the target object. As a result, an action is exerted on the target object based on a motion of the hand of the user 5.

The subject matters described herein are described as, for example, the following items.

### (Item 1)

There is provided an information processing method to be executed by a computer (computer 200 or computer included in server 600) in order to provide a virtual experience to a user 5 via a user terminal (HMD 120). The information processing method includes acquiring first content data for defining a virtual space 11 for providing the virtual experience (Step S1831 of FIG. 18). The information processing method further includes generating the virtual space 11 based on the first content data (Step S1832 of FIG. 18). The information processing method further includes generating image data P1 corresponding to a portion of the virtual space 11 (Step S1833 of FIG. 18). The information processing method further includes associating the image data P1 and the first content data with each other (Step S1834 of FIG. 18). The information processing method further includes detecting a replacement from the first content data to second content data (Step S1835 in FIG. 18). The information processing method further includes updating, when the replacement is detected, the image data P1 in accordance with the second content data (Step S1836 of FIG. 18).

With the information processing method of this item, the image data P1 generated at a certain point in time is able to be changed in accordance with the replacement of the content data. As a result, the entertainment value of the virtual experience of the user 5 can be improved.

### (Item 2)

The information processing method according to Item 1, wherein the user terminal includes at least a head-mounted device (HMD 120) to be controlled by the computer. The method further includes generating a field-of-view image based on the virtual space 11 and a motion of the user terminal, and displaying the field-of-view image on a display (monitor 130) of the head-mounted device (Step S1510 of FIG. 15). The generating of the image data P1 includes generating the image data P1 based on the portion of the virtual space 11 designated by the user 5 while the virtual experience is provided to the user 5.

With the information processing method of this item, an experience of generating (photographing) image data is provided to a user during the virtual experience, and thus the virtual experience of the user may be enriched.

### (Item 3)

The information processing method according to Item 2, wherein the generating of the image data P1 includes generating the image data P1 based on viewpoint information defining the field-of-view image.

With the information processing method of this item, image data representing the same image as the field-of-view image provided to the user can be generated.

### (Item 4)

The information processing method according to Item 2, wherein the virtual space 11 further includes a photography object to be operated by an avatar (character object) associated with the user 5. The generating of the image data P1 includes generating the image data P1 based on viewpoint information associated with the photography object.

With the information processing method of this item, image data representing an image different from the field-of-view image is generated and provided to the user.

### (Item 5)

The information processing method according to Item 4, wherein the virtual space 11 further includes an operation object configured to move in accordance with a motion of a part of a body of the user 5. The photography object receives an input operation by the operation object. The generating of the image data P1 includes generating the image data P1 based on the viewpoint information at a timing when the input operation is received by the photography object.

With the information processing method of this item, in the virtual space 11, the user is provided with an experience of performing a photography operation by a photography object (i.e., an experience as if he or she were photographing in the real space with a camera), and hence the virtual experience of the user may be enriched.

### (Item 6)

The information processing method according to any one of Items 2 to 5, wherein the user terminal further includes a terminal device different from the head-mounted device. The displaying of the image data P1 includes displaying the image data P1 on a display included in the terminal device.

With the information processing method of this item, the image data photographed in the virtual space 11 is viewable in a real space, which enables the entertainment value for the user to be improved.

### (Item 7)

The information processing method according to any one of Items 1 to 6, wherein the image data P1 includes a first portion (layer image P2) corresponding to a character object (avatar 6A) associated with the user and a second portion (layer image P3) depending on the content data to be applied. The updating of the image data P1 includes updating the second portion of the image data in accordance with the second content data.

With the information processing method of this item, the image data is easily updated by changing only the portion affected by the content data in accordance with the replacement of the content data.

### (Item 8)

The information processing method according to Item 7, wherein the updating of the image data P1 includes updating a display mode of the first portion of the image data based on the second content data.

With the information processing method of this item, image data in which the first portion and the second portion after replacement are consistent with each other can be obtained by changing not only the display mode of the second portion but also the display mode of the first portion in accordance with the content of the content data.

### (Item 9)

The information processing method according to any one of Items 1 to 8, further including sequentially updating, when a condition determined in advance is established, the image data in accordance with the content data to be applied, while switching in an order determined in advance the content data to be applied among a plurality of pieces of content data for defining the virtual space.

With the information processing method of this item, for example, the user 5 is able to view changes over time in a predetermined place, which enables the virtual experience of the user 5 using the image data to be enriched.

### (Item 10)

An apparatus for executing the information processing method of any one of Items 1 to 9.

### (Item 11)

An apparatus, including at least:

a memory; and

a processor coupled to the memory,

the apparatus being configured to execute the information processing method of any one of Items 1 to 9 under control of the processor.

1. A method, comprising:
acquiring first content data;
defining a virtual space based on the first content data;
generating image data of a still image corresponding to a portion of the virtual space;
associating the image data with the first content data;
receiving instructions for replacing the first content data with second content data; and
updating the image data to replace the first content data with the second content data in response to the receiving of the instructions for replacing.

2. The method according to claim 1, further comprising:
detecting a motion of a head-mounted device (HMD) including a display;
generating a field-of-view image in accordance with the detected motion of the HMD;
displaying the field-of-view image on the display;
receiving a photography instruction by the user under a state in which the visual-field image is displayed on the display; and
generating the image data in response to the photography instruction.

3. The method according to claim 2,
wherein the virtual space further comprises a virtual viewpoint, and
wherein the generating of the image data comprises generating the image data based on a position of the virtual viewpoint in the virtual space.

4. The information processing method according to claim 2,
wherein the virtual space further comprises a photography object,
wherein the photography object is operable by a character object associated with the user, and
wherein the generating of the image data comprises generating the image data based on a position and a direction of the photography object in the virtual space.

5. The method according to claim 4,
wherein the virtual space further comprises an operation object, and
wherein the method further comprises:
detecting a motion of a part of a body of the user;
moving the operation object in the virtual space in accordance with the detected motion;
receiving an input operation to the photography object based on a positional relationship in the virtual space between the operation object and the photography object; and
generating the image data at a timing when the input operation is received.

6. The method according to claim 2, wherein the displaying of the image data comprises displaying the image data on a display included in a terminal device different from the HMD.

7. The method according to claim 1,
wherein the content data includes panorama image data defining a background of the virtual space,
wherein the defining of the virtual space comprises defining the virtual space based on the content data and object data,
wherein the object data defines an appearance and a motion of a character object associated with the user,
wherein the image data includes a first portion and a second portion,
wherein the first portion corresponds to the character object, and the second portion corresponds to the panorama image, and
wherein the method further comprises updating the second portion of the image data in response to the replacing of the first content data with the second content data in response to receiving the instructions for replacing.

8. The method according to claim 7, further comprises changing a color tone of the first portion of the image data based on the second content data in response to receiving the instructions for replacing.

9. The method according to claim 1, further comprising sequentially updating, in response to establishment of a condition determined in advance, the image data while switching the first content data to the second content data in an order determined in advance.
